(19) United States
(12) Patent Application Publication
(10) Pub. No.: US 2006/0044799 A1
(43) Pub. Date: Mar. 2, 2006

(54) Cylinder lens array and projection system employing the same

(76) Inventor: Dae-Sik Kim, Suwon-si (KR)

Correspondence Address: SUGHRUE MION, PLLC, 2100 PENNSYLVANIA AVENUE, N.W., SUITE 800, WASHINGTON, DC, 20037, US

(21) Appl. No.: 10/519,547

(22) PCT Filed: May 23, 2003
(86) PCT No.: PCT/KR03/01018

§ 371 Date: Aug. 9, 2005

(30) Foreign Application Priority Data
Jun. 28, 2002 (KR) 10-2002-0036851

(51) Int. Cl. F21V 5/00

(52) U.S. Cl. 362/268; 362/331; 362/332

(57) ABSTRACT

A cylinder lens array and a projection system adopting the same are provided. The cylinder lens array is installed on a path of a light beam emitted from a light source and is comprised of lens cells. The lens cells are arrayed with their central axes inclined at different angles, so that the light beam which diverges symmetrically with respect to its optical axis is aligned so as to reduce the angle of the divergence in a certain direction. The cylinder lens array is applicable to both single-panel projection systems and three-panel projection systems. In particular, when the cylinder lens array is applied to projection systems adopting a scrolling method, the effects of light alignment are maximized. Thus, etendue decreases, and light efficiency increases.

### BACKGROUND OF THE INVENTION

The present invention relates to a cylinder lens array and a projection system employing the same, and more particularly, to a cylinder lens array providing increased light efficiency by reducing the etendue of an optical system by aligning light beams emitted from a light source, and a projection system adopting the cylinder lens array.

Projection systems are classified into three-panel projection systems and single-panel projection systems according to the number of light valves that form an image by controlling the on-off operation of a high-output lamp used as a light source. Single-panel projection systems have a smaller optical system than the optical system of three-panel projection systems. However, since single-panel projection systems use R, G, and B colors into which white light is sequentially divided, the light efficiency of each of the R, G, and B colors is only ⅓ of that of three-panel type projection systems. Hence, attempts to increase the light efficiency of single-panel projection systems have been made.

As shown in FIG. 1A, in a conventional single-panel scrolling projection system, white light radiated from a light source 100 passes through first and second lens arrays 102 and 104 and a polarized beam splitter array 105 and is then separated into R, G, and B colors by first through fourth dichroic filters 109, 112, 122, and 139. To be more specific, for example, R and G light beams are transmitted by the first dichroic filter 109 and advance along a first light path I1, while a B light beam is reflected by the first dichroic filter 109 and advances along a second light path I2. The R and G light beams traveling along the first light path I1 are separated by the second dichroic filter 112. The R light beam is transmitted by the second dichroic filter 112 and advances along the first light path I1, while the G light beam is reflected by the second dichroic filter 112 and advances along a third light path I3.

As described above, the light emitted from the light source 100 is separated into the R, G, and B light beams, and the R, G, and B light beams are then scrolled while passing through first, second, and third prisms 114, 135, and 142, respectively. The first, second, and third prisms 114, 135, and 142 are installed on the first, second, and third light paths I1, I2, and I3 and rotate at a uniform speed, thereby scrolling R, G, and B color bars. The B and G light beams traveling along the second and third light paths I2 and I3, respectively, are transmitted and reflected, respectively, by the third dichroic filter 139, and then combined. Finally, the R, G, and B light beams are combined by the fourth dichroic filter 122, pass through a polarized beam splitter 127, and then form an image using a light valve 130.

FIG. 1B shows scrolling of R, G, and B color bars by the rotation of the first, second, and third prisms 114, 135, and 142. As shown in FIG. 1B, R, G, and B color bars formed on the surface of the light valve 130 move when the first, second, and third prisms 114, 135, and 142 rotate synchronously.

A color image obtained by turning on or off the individual pixels of the light valve 130 according to an image signal is magnified by a projection lens. Then, the magnified image lands on a screen.

In the above-described single-panel scrolling projection system, because different light paths are used for different colors, different lenses for different colors are required, and component parts for combining divided light beams are also required. Thus, the size of the conventional projection system increases, and its assembly is difficult. Also, complicated light paths make alignment of optical axes difficult. While divided colors are being combined, the etendue of an optical system increases. The etendue (E) denotes an optical conservation quantity in an optical system and is calculated using Equation 1:

$$E = π A sin 2 ( {θ}_{\frac{1}{2}} ) = \frac{π A}{{( 2 Fno )}^{2}} \qquad ( 1 )$$

wherein A denotes the area of an object whose etendue is to be measured, θ_{1/2} denotes half of a divergence angle of a light beam incident upon or emitted from the object, and Fno denotes the F-number of a lens used in the optical system. According to Equation 1, the etendue (E) is determined by the area of the object and the F-number of a lens. The etendue, which depends on the geometric structure of an optical system, must be the same at the starting and ending points of the optical system in order to obtain an optimal light efficiency. If the etendue at the starting point is greater than that at the ending point, the optical system becomes bulky. If the etendue at the starting point is smaller than that at the ending point, light loss may be generated. If the etendue of a light source is high, the range of angles at which light beams are incident upon a subsequent lens increases, making it difficult to properly configure the optical system. Therefore, the etendue of an illumination system can be reduced to easily configure an optical system.

A conventional light engine for reducing etendue is disclosed in U.S. Pat. No. 6,356,700 B1. Referring to FIG. 2, the light engine includes a primary reflector system 152, which is installed at one side of an aligned structure of a cathode electrode 154 and an anode electrode 156, and a retro reflector system 150 installed on the other side of the aligned structure of a cathode electrode 154 and an anode electrode 156 to face the primary reflector system 152. The primary reflector system 152 and the retro reflector system 150 are installed such that light beams are emitted from the tips of the cathode electrode 154 and the anode electrode 156 at a divergence angle θₕ.

As described above, etendue can be reduced by controlling the divergence angle of light by changing the structure of a light source. However, changing the structure of a light source in order to reduce etendue requires a development of a new optimal light source and substitution of an existing light source, which cost money. Also, light reflected by the retro reflector system 150 may return to the electrodes 154 and 156 and adversely affect the efficiency and durability of the light source. Thus, the output of light is reduced.

### SUMMARY OF THE INVENTION

The present invention provides a cylinder lens array which provides increased light efficiency by reducing etendue by asymmetrically aligning light that is emitted from a light source and symmetrically distributed by reducing the angle of divergence in a certain direction, and a projection system adopting the cylinder lens array.

According to an aspect of the present invention, there is provided a cylinder lens array which is installed on a path of a light beam emitted from a light source and comprised of lens cells arrayed in such a way that their central axes are inclined at different angles, so that the light beam which diverges symmetrically with respect to its optical axis is aligned so as to reduce the angle of the divergence in a certain direction.

The lens cells are arrayed such that the inclination angles of their central axes increase with distance from the center of the cylinder lens array.

The lens cells are arrayed in curved rows.

The lens cells are incorporated by connecting their central axes.

The cylinder lens array is symmetric about its vertical bisector and about its horizontal bisector, and is point-symmetric with respect to its center.

The lens cells are arrayed such that their central axes are inclined at angles each corresponding to the sum of the incidence angle of an incident beam with respect to a vertical central axis of the cylinder lens array and half of an angle by which the incident beam is to be rotated.

According to another aspect of the present invention, there is provided a projection system which forms an image by processing light emitted from a light source using a light valve in response to an input image signal and magnifies and projects the image onto a screen through a projection lens unit. The projection system includes a pair of cylinder lens arrays which are installed on a path of a light beam emitted from the light source and each are comprised of lens cells arrayed with central axes inclined at different angles, so that the light beam which diverges symmetrically with respect to its optical axis is aligned so as to reduce the angle of the divergence in a certain direction.

### BRIEF DESCRIPTION OF THE DRAWINGS

FIG. 1A is a schematic view of the configuration of a conventional projection system;

FIG. 1B illustrates how color bars are scrolled in a conventional projection system;

FIG. 2 shows a conventional light engine for reducing etendue;

FIG. 3A is a picture showing a radial distribution of light radiated from a light source;

FIG. 3B shows a comparison of a radial distribution of light radiated from a light source with the shape of a light valve;

FIG. 3C shows the relationship between the distribution of light emitted from a light source and a divergence angle;

FIG. 4 shows the structure of a cylinder lens array according to a first embodiment of the present invention;

FIGS. 5A through 5C illustrate a principle of rotating an image using a cylinder lens array according to the present invention;

FIGS. 6A through 6C illustrate an example in which a divergence angle is controlled using a lens cell of a cylinder lens array according to the present invention;

FIGS. 7A through 7D are side views and front views obtained by simulation illustrating the divergence angle of light when a cylinder lens array according to a preferred embodiment of the present invention is used and when no cylinder lens arrays are used;

FIG. 8 shows the structure of a cylinder lens array according to a second embodiment of the present invention;

FIG. 9 shows the structure of a cylinder lens array according to a third embodiment of the present invention;

FIG. 10 is a schematic view of the configuration of a projection system according to the present invention;

FIG. 11 shows a projection system according to the present invention in which an aberration correction lens is further installed between a pair of cylinder lens arrays; and

FIG. 12 shows the structure of a cylinder lens array according to a fourth embodiment of the present invention.

### DETAILED DESCRIPTION OF THE INVENTION

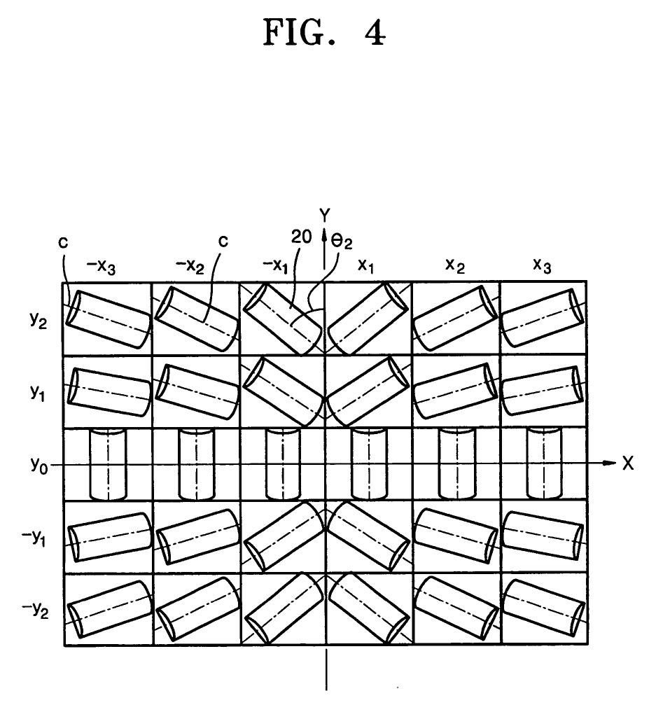

Referring to FIG. 4, a cylinder lens array according to a first embodiment of the present invention is comprised of lens cells 20 having different central axes so as to reduce etendue by aligning light distributed radially from a light source in one direction.

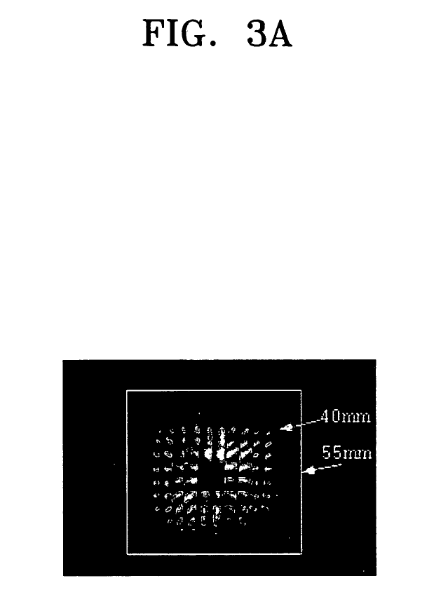

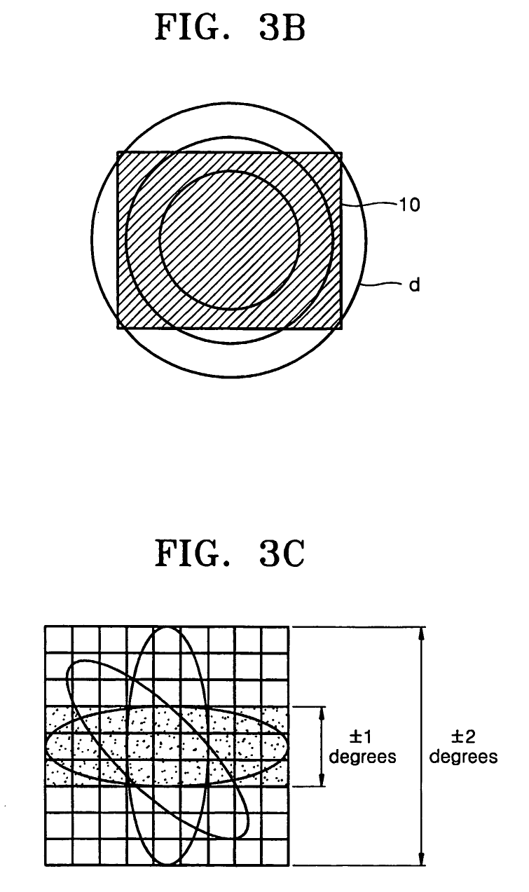

A process of changing a radial light distribution into an asymmetrical light distribution using a cylinder lens array according to the present invention will now be described. As shown in FIG. 3A, light emitted from a lamp light source has a radial distribution. Since an aspect ratio of a screen is 4:3 or 16:9, a light valve 10 included in a projection system generally has a rectangular shape and an aspect ratio of 4:3 or 16:9. In FIG. 3B, the radial distribution (d) of light emitted from a light source is compared with the rectangular shape of the light valve 10. As shown in FIG. 3B, because the light valve 10 is rectangular whereas light emitted from the light source has a radial distribution, some light is not incident on the light valve 10, and thus the light efficiency of the system in forming a final image is degraded.

The light efficiency can be increased by light alignment to match the distribution of light emitted from a light source to the shape of the light valve 10. As shown in FIG. 3C, the divergence angle of light due to a light distribution is ±1 to ±2 degrees.

As described above, the present invention includes a cylinder lens array to serve as a light alignment unit for controlling the distribution of light emitted from a light source. Referring to FIG. 4, the lens cells 20 of the cylinder lens array according to the first embodiment of the present invention are arranged in such a way that their respective central axes (c) are inclined at various angles ranging from 0 to 45 degrees depending on locations of the lens cells 20 so that radially distributed light is aligned in one direction. The present invention uses a pair of cylinder lens arrays each having such a structure.

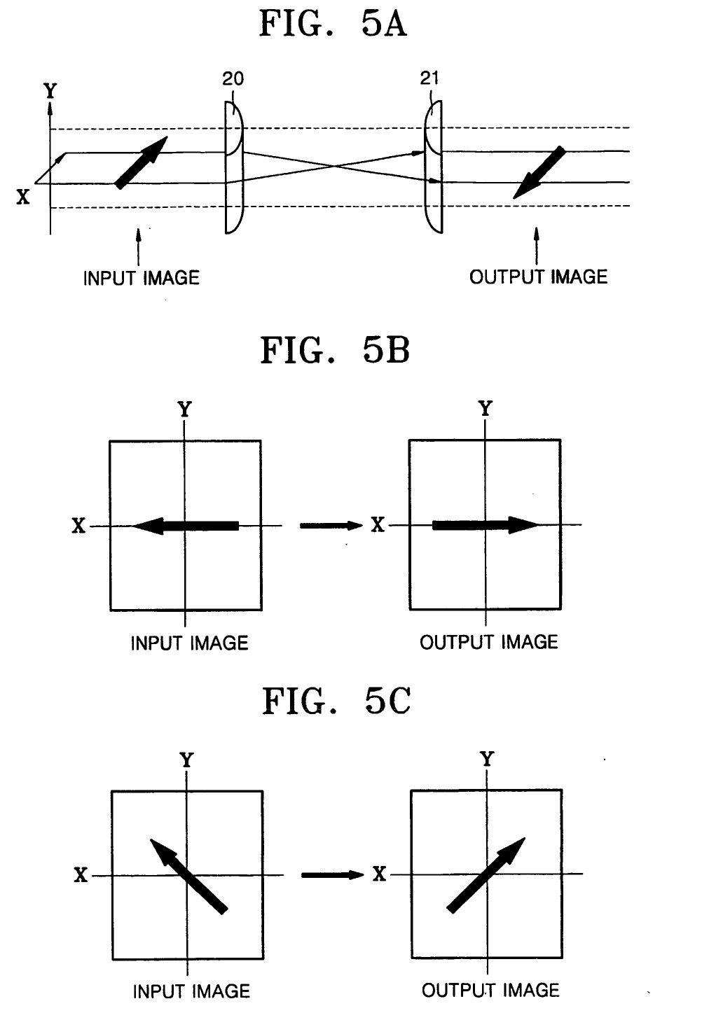

FIGS. 5A through 5C illustrate a process in which an image is rotated by a pair of cylinder cells 20 and 21. As shown in FIG. 5A, when an image pointing in a direction X passes through the pair of cylinder lens cells 20 and 21, it is rotated by 180 degrees and output so that it points in the direction −X. FIG. 5B two-dimensionally shows the image rotation of FIG. 5A. In an alternative example, as shown in FIG. 5C, when an image is incident at −45 degrees with respect to an X axis, it is rotated 90 degrees to obtain an output image pointing in the direction of 45 degrees. The alternative example of FIG. 5C corresponds to an image rotation when the central axes of the lens cells 20 and 21 stand in a Y axial direction. Hence, desired image rotations can be achieved by changing the central axes of the lens cells 20 and 21. In other words, when illuminating light is diffused in a vertical direction Y, if a pair of lens cells are arrayed so that their central axes are at 45 degrees, the light is rotated by 90° so that an output beam is diffused in a horizontal direction X.

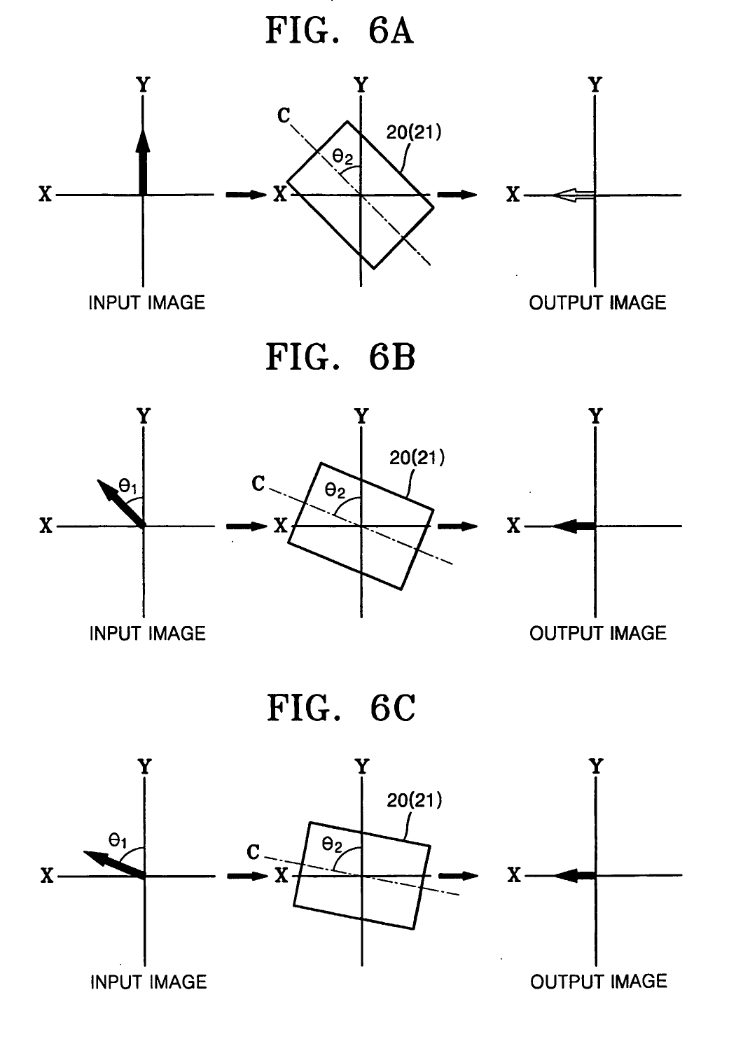

As described above, divergent light beams can be aligned in a horizontal direction by arraying a pair of opposite lens cells so that their central axes are inclined at a predetermined angle with the vertical direction Y depending on the divergence angle of input light. As shown in FIG. 6A, if an input image or an incident beam is incident in the Y axial direction, a pair of lens cells 20 and 21 are arrayed in such a way that their central axes (c) are inclined at θ₂ (=−45 degrees) with respect to the Y axis, so that the input image or incident beam is rotated by 90 degrees to obtain an output image or an emitted beam oriented in the X axial direction. As shown in FIG. 6B, if an input image or an incident beam is incident at θ₁ (=−45 degrees), the pair of lens cells 20 and 21 are arrayed in such a way that their central axes (c) are inclined at θ₂ (=−67.5 degrees) with respect to the Y axis, so that an output image or an emitted beam is aligned in the X axial direction. As shown in FIG. 6C, if an input image or an incident beam is incident at θ₁ (=−67.5 degrees), the pair of lens cells 20 and 21 are arrayed in such a way that their central axes (c) are inclined at θ₂ (=−78.25 degrees) with respect to the Y axis, so that an output image or an emitted beam is aligned in the X axial direction. To sum up, the inclination angle of the central axis of a lens cell is set to the sum of the incidence angle of an input image or incident beam and half of an angle by which the input image or incident beam is rotated.

The configuration of a cylinder lens array based on the above-described principle according to the present invention will now be described. If a cylinder lens array is comprised of 6×5 lens cells 20, the central axes (c) of the lens cells 20 are inclined at angles shown in Table 1:

TABLE 1

| | −x₃ | −x₂ | −x₁ | x₁ | x₂ | x₃ |
|---|---|---|---|---|---|---|
| y₂ | −70.73 | −63.49 | −51.28 | 51.28 | 63.49 | 70.73 |
| y₁ | −79.14 | −73.30 | −57.14 | 57.14 | 73.30 | 79.14 |
| y₀ | 0 | 0 | 0 | 0 | 0 | 0 |
| −y₁ | −100.86 | −106.7 | −122.86 | 122.86 | 106.7 | 100.86 |
| −y₂ | −109.27 | −116.52 | −128.72 | 128.72 | 116.52 | 109.27 |

In FIG. 4, the lens cells 20 are represented in a XY coordinate system. Here, the X and Y coordinate axes correspond to the horizontal and vertical directions, respectively, of a cylinder lens array. Referring to Table 1 and FIG. 4, the farther from the X and Y axes of the cylinder lens array a lens cell 20 is positioned, the larger the inclination angle (θ₂) of the central axes (c) of the lens cell 20 becomes. For example, a lens cell 20 corresponding to (−x₃, y₂) is disposed such that its central axis (c) is at −70.73 degrees, and a lens cell 20 corresponding to (−x₂, y₂) is disposed such that its central axis (c) is at −63.49 degrees. In Table 1, a negative sign (−) denotes an angle measured counterclockwise from the Y axis, and a positive sign (+) denotes an angle measured clockwise from the Y axis.

Other lens cells 20 are arrayed so as to be symmetrical with the lens cells 20 corresponding to (−x₁, y₂), (−x₂, y₂), (−x₃, y₂), (−x₂, y₁), (−x₂, y₁), and (−x₃, y₁) as shown in FIG. 4.

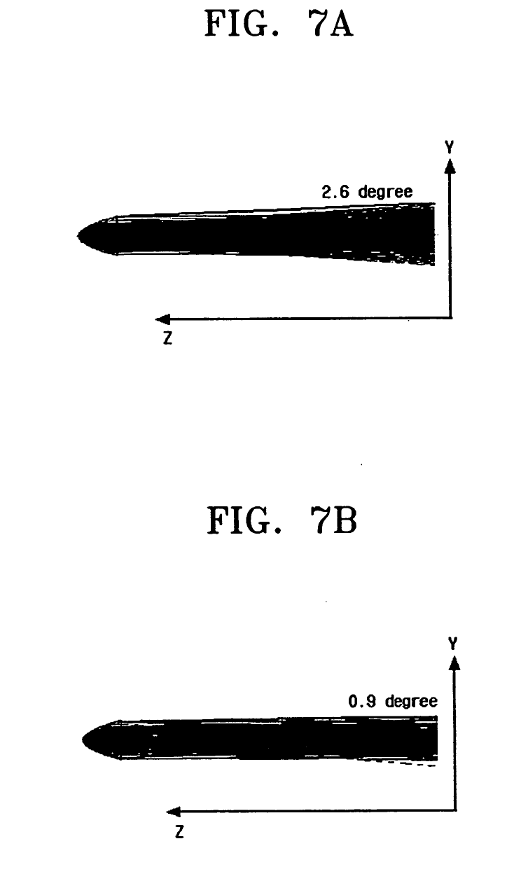

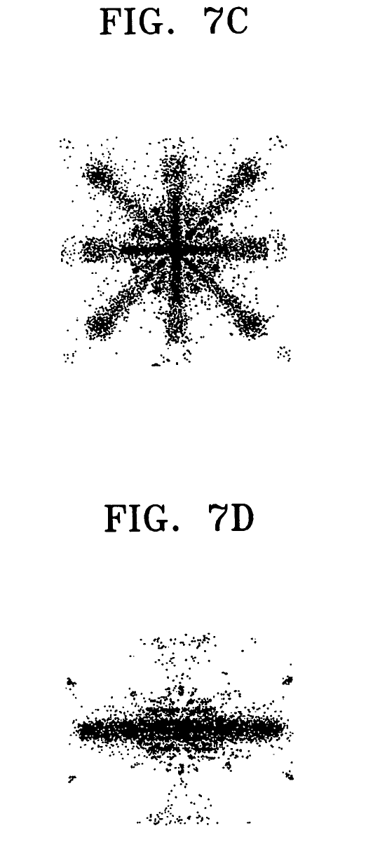

FIGS. 7A through 7D show the results of a simulation of the effects of a cylinder lens array configured by a combination of lens cells as described above on radially-divergent light emitted from a lamp light source. When a light distribution (shown in FIG. 7A) of light from a lamp light source measured from a far field of vision using a pin hole without using a cylinder lens array according to the present invention is compared with a light distribution (shown in FIG. 7B) measured from a far field of vision using a cylinder lens array according to the present invention, a radiation angle was reduced from 2.6 degrees to 0.9 degrees. FIGS. 7C and 7D are cross-sections of a light beam taken perpendicular to the optical axis when a cylinder lens array according to the present invention is not used and when a cylinder lens array according to the present invention is used, respectively.

As described above, a symmetrical distribution of a divergent light beam can be changed to an asymmetrical distribution by reducing the angle of divergence of the divergent light in a certain direction using a cylinder lens array according to the present invention. As a result, the etendue of an optical system is reduced, causing an increase in light efficiency. Also, the divergent light beam has a distribution corresponding to the aspect ratio of a light valve, thereby minimizing light loss.

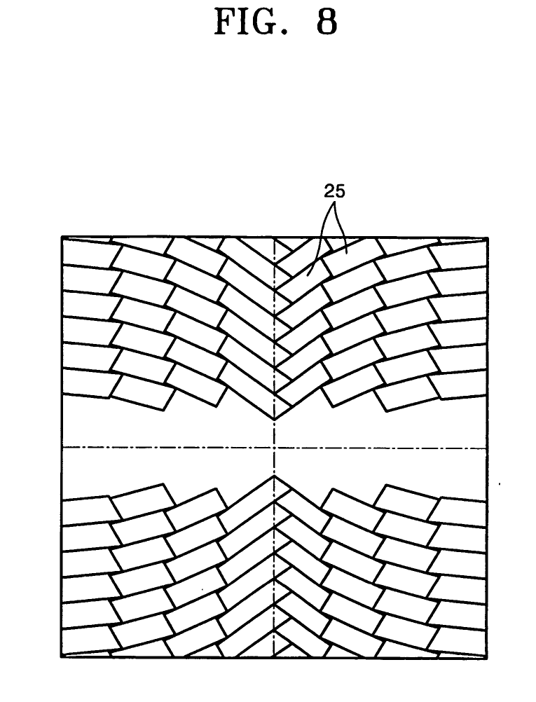

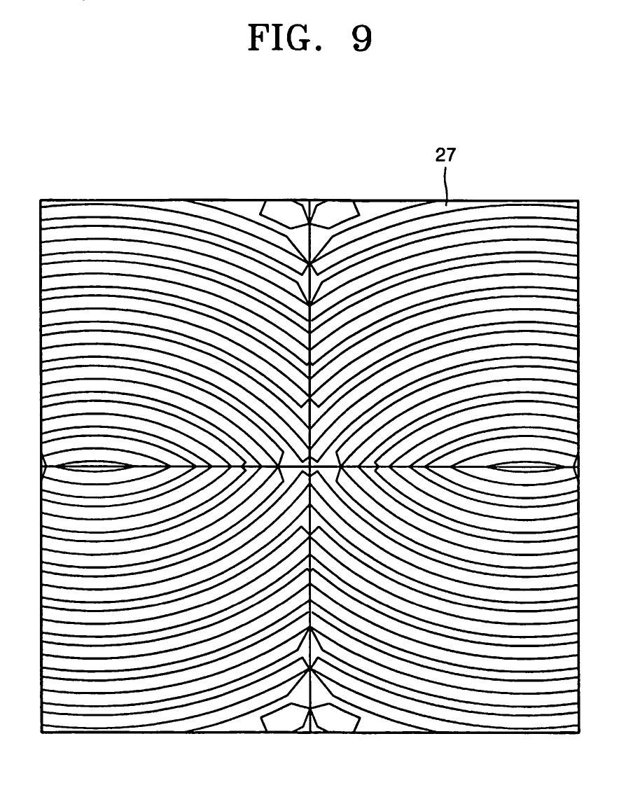

As shown in FIG. 8, a cylinder lens array according to a second embodiment of the present invention is comprised of lens cells 25. The lens cells 25 are arrayed in curved rows. In other words, the inclination of their central axes continuously increases from the middle to the left and right edges of the cylinder lens array. As the number of lens cells 25 increases, a light loss area between lens cells is minimized, thereby maximizing light efficiency.

If the central axes of adjacent lens cells aligned in one direction are inclined consecutively, the lens cells may be connected to one another along their central axes and incorporated into a single lens cell. FIG. 9 shows a cylinder lens array comprised of cylinder lenses 27 made up of lens cells connected to one another along their central axes. The formation of a cylinder cell 27 by lens cells contributes to simplify a process for manufacturing cylinder lens arrays.

The cylinder lens arrays according to the first and second embodiments can be favorably applied to both single-panel projection systems and three-panel projection systems. In particular, the cylinder lens arrays can be favorably applied to both single-panel projection systems that produce R, G, and B colors using color filters and single-panel cylinder lens that produce R, G, and B colors using a scrolling method.

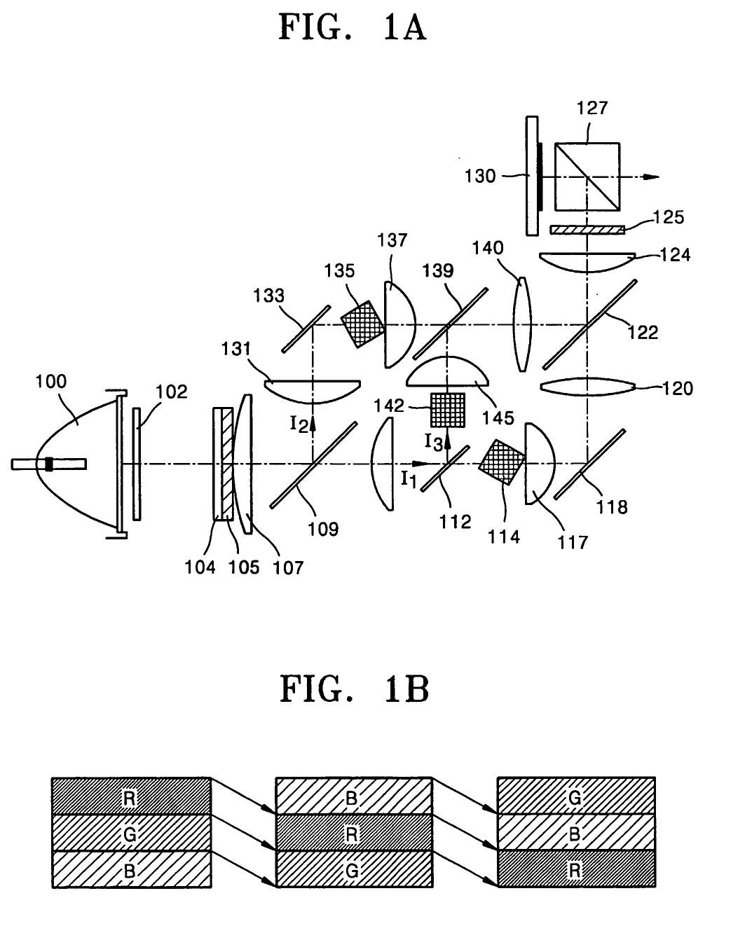

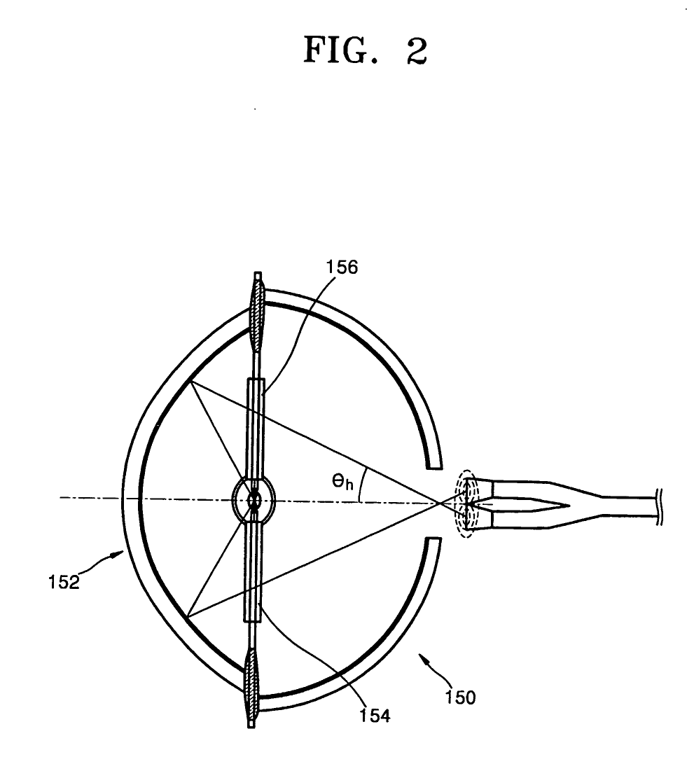

The correlation between the radial distribution of light from a light source and the aspect ratio of a light valve affects single-panel projection systems adopting a scrolling method more than single-panel projection systems adopting color filters. To be more specific, in single-panel projection systems adopting a scrolling method, a light valve is divided into three parts in order to form three R, G, and B color bars as shown in FIG. 1B. Accordingly, in projection systems adopting a scrolling method, it is very important that light from a light source is properly aligned with and projected only onto the area of a light valve for a single color bar. This is less important in projection systems in which the entire area of a single light valve is used to obtain a single color.

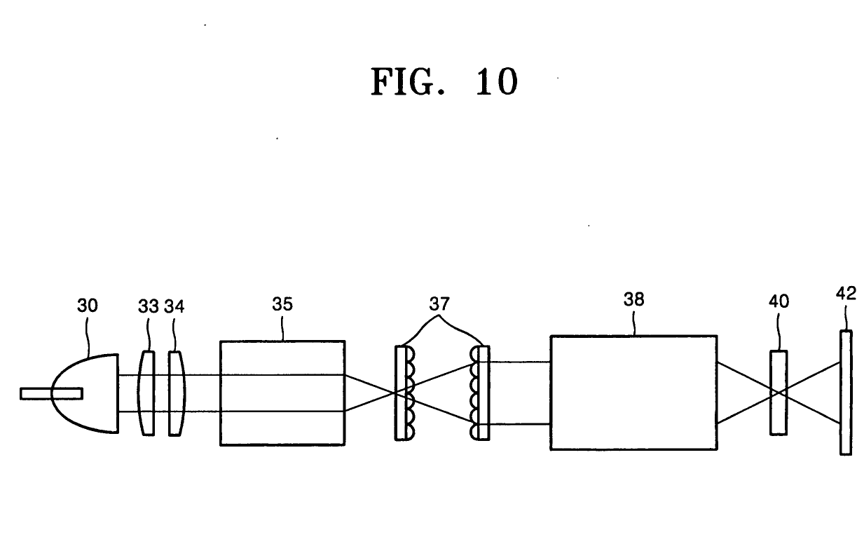

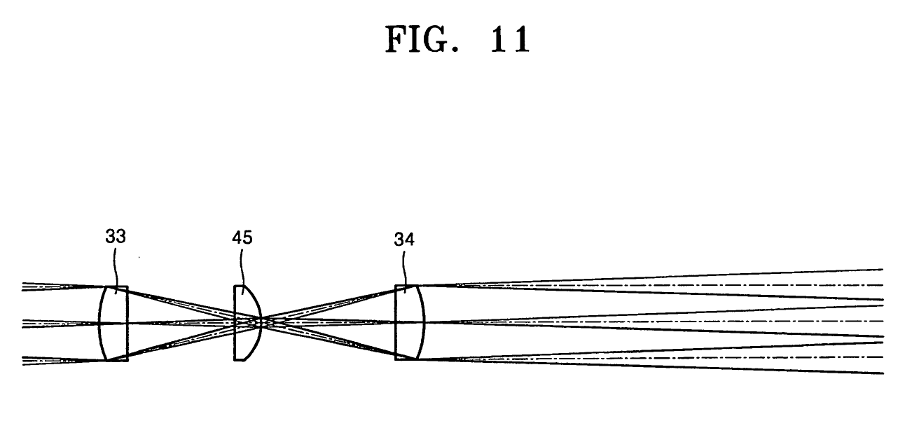

Considering the above, greater light efficiency can be expected by applying a cylinder lens array to projection systems adopting a scrolling method. As shown in FIG. 10, in a projection system according to a preferred embodiment of the present invention, radially symmetrical light beams are emitted from a light source 30 and aligned by a pair of first and second cylinder lens arrays 33 and 34 so as to reduce the angle of divergence in a certain direction. Using the aligned light beams, a light valve 40 controls the on-off operation of each pixel in response to an input signal, thereby forming an image. The image formed by the light valve 40 is magnified and projected onto a screen (not shown) through a projection lens unit 42.

Each of the first and second cylinder lens arrays 33 and 34 can have the array structure of the lens cells 20 of FIG. 4, in which the lens cells 20 are disposed with their central axes (c) inclined at different angles ranging from 0 to 45 degrees depending on the location of the lens cells 20, such that radially-distributed light beams are aligned in one direction. In other words, a light beam with a circular cross-section (profile) is flattened in the vertical direction to more closely match the shape of the rectangular light valve 40. Alternatively, each of the first and second cylinder lens arrays 33 and 34 can be the cylinder lens array of FIG. 8 or 9, in which lens cells are disposed such that their central axes become more inclined consecutively. The first and second cylinder lens arrays 33 and 34 are disposed such that their curved surfaces either face each other or face away from each other as shown in FIG. 10.

As shown in FIG. 11, an aberration correction lens 45 for preventing beam diffusion due to aberration can be further installed between the first and second cylinder lens arrays 33 and 34.

As shown in FIG. 10, in projection systems adopting a scrolling method, a scrolling unit 35 having an optical separator (not shown) for separating a light beam emitted from the light source 30 into three color light beams is installed on the light path between the pair of first and second cylinder lens arrays 33 and 34 and the light valve 40. The projection systems adopting a scrolling method can further include a fly eye lens 37 which equalizes light beams passed through the scrolling unit 35, and a relay lens 38 for collecting the beams passed through the fly eye lens 37.

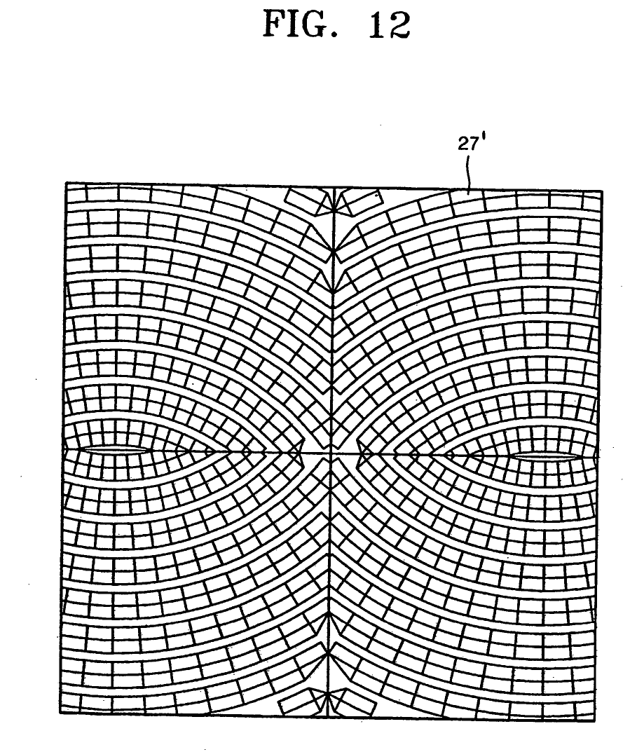

Also, as shown in FIG. 12, lens cells 27′ are arrayed in successive curved rows.

As described above, a projection system according to the present invention reduces the etendue of an optical system and simultaneously maximizes light efficiency by aligning distributed light using the first and second cylinder lens arrays 33 and 34.

As described above, a cylinder lens array according to the present invention is comprised of lens cells disposed such that their central axes are inclined at different angles depending on the location of the lens cells. Hence, light beams emitted from a light source and radially distributed are aligned in one direction, thereby increasing light efficiency. In particular, the light alignment makes a light distribution correspond to the aspect ratio of a light valve, thus reducing etendue and maximizing light efficiency.

### INDUSTRIAL APPLICABILITY

The cylinder lens array according to the present invention is applicable to both single-panel projection systems and three-panel projection systems, and also to projection systems adopting a scrolling method. In particular, when the cylinder lens array according to the present invention is applied to projection systems adopting a scrolling method, the effects of light alignment are greater.

1. A cylinder lens array which is installed on a path of light emitted from a light source and comprised of lens cells arrayed in such a way that central axes of the lens cells are inclined at different angles, so that a light beam which diverges symmetrically with respect to its optical axis is aligned so as to reduce an angle of the divergence in a certain direction.

2. The cylinder lens array of claim 1, wherein the lens cells are arrayed such that the inclination angles of the central axes increase with distance from the center of the cylinder lens array.

3. The cylinder lens array of claim 1, wherein the lens cells are arrayed in curved rows.

4. The cylinder lens array of claim 1, wherein the lens cells are arrayed such that the central axes change consecutively.

5. The cylinder lens array of claim 3 or 4, wherein the lens cells are incorporated by connecting the central axes.

6. The cylinder lens array of any of claims 1 through 4, wherein the cylinder lens array is symmetric about its vertical bisector and about its horizontal bisector, and is point-symmetric with respect to its center.

7. The cylinder lens array of any of claims 1 through 4, wherein the lens cells are arrayed such that the central axes are inclined at angles each corresponding to the sum of an incidence angle of an incident beam with respect to a vertical central axis of the cylinder lens array and half of an angle by which the incident beam is to be rotated.

8. A projection system which forms an image by processing light emitted from a light source using a light valve in response to an input image signal and magnifies and projects the image onto a screen through a projection lens unit, the projection system comprising:
a pair of cylinder lens arrays which are installed on a path of a light beam emitted from the light source and each is comprised of lens cells arrayed with central axes inclined at different angles, so that a light beam which diverges symmetrically with respect to its optical axis is aligned so as to reduce an angle of the divergence in a certain direction.

9. The projection system of claim 8, wherein the lens cells are arranged such that inclination angles of the central axes increase with distance from the center of the cylinder lens array.

10. The projection system of claim 8, wherein the lens cells are disposed such that the central axes are arrayed in curved rows.

11. The projection system of claim 8, wherein the lens cells are arrayed such that the central axes change consecutively.

12. The projection system of claim 10 or 11, wherein the lens cells are incorporated by connecting the central axes.

13. The projection system of any of claims 8 through 11, wherein the cylinder lens array is symmetric about its vertical bisector and about its horizontal bisector and is point-symmetric with respect to its center.

14. The projection system of any of claims 8 through 11, wherein the lens cells are arrayed such that the central axes are inclined at angles each corresponding to the sum of an incidence angle of an incident beam with respect to a vertical central axis of the cylinder lens array and half of an angle by which the incident beam is to be rotated.

15. The projection system of any of claims 8 through 11, wherein the cylinder lens arrays are disposed such that the light beam radially emitted from the light source is aligned so that the light distribution corresponds to the size of the light valve.

16. The projection system of any of claims 8 through 11, further comprising a scrolling unit for scrolling an incident light beam and a color separator for separating an incident light beam into different color light beams, wherein the scrolling unit and the color separator are installed on the light path between the pair of cylinder lens arrays and the light valve.

17. The projection system of any of claims 8 through 11, further comprising an aberration correction lens installed between the cylinder lens arrays.
